(19) United States
(12) Patent Application Publication
(10) Pub. No.: US 2025/0230555 A1
(43) Pub. Date: Jul. 17, 2025

(54) VANADIUM-DOPED MANGANESE COBALT SPINEL OXIDE BASED ELECTROCATALYSTS FOR GENERATING HYDROGEN

(71) Applicant: KING FAHD UNIVERSITY OF PETROLEUM AND MINERALS, Dhahran (SA)

(72) Inventors: Mohamed Jaffer Sadiq MOHAMED, Dhahran (SA); Muhammad Ashraf GONDAL, Dhahran (SA)

(73) Assignee: KING FAHD UNIVERSITY OF PETROLEUM AND MINERALS, Dhahran (SA)

(21) Appl. No.: 18/413,831

(22) Filed: Jan. 16, 2024

(51) Int. Cl. C25B 1/04; C25B 11/054; C25B 11/065; C25B 11/077

(52) U.S. Cl. CPC C25B 1/04; C25B 11/054; C25B 11/065; C25B 11/077

(57) ABSTRACT

A method of generating hydrogen including applying a potential of −0.1 volts (V) to −1.0 V to an electrochemical cell, and the electrochemical cell is at least partially submerged in an aqueous solution. Further, on the application of the potential, the aqueous solution is reduced, thereby forming hydrogen. The electrochemical cell includes an electrocatalyst and a counter electrode. The electrocatalyst includes a substrate and vanadium-doped manganese spinel oxide microspheres (MnVₓCo₂₋xO₄) particles. The value of x is ≤0.4, the MnVₓCo₂₋ₓO₄ particles have a spherical shape, the MnVₓCo₂₋ₓO₄ particles have an average diameter of less than 100 nanometers (nm), and the MnVₓCo₂₋ₓO₄ particles are dispersed on the substrate to form the electrocatalyst.

### STATEMENT OF PRIOR DISCLOSURE BY INVENTOR

Aspects of the present disclosure are described in Mohamed, M. J. S., Slimani, Y., Gondal, M. A., Almessiere, M. A., Baykal, A., Hassan, M., Khan, A. Z. and Roy, A., “Role of vanadium ions substitution on spinel MnCo₂O₄ towards enhanced electrocatalytic activity for hydrogen generation” Sci Rep; 2023; 13, 2120, incorporated herein by reference in its entirety.

### STATEMENT OF ACKNOWLEDGEMENT

Support provided by the King Fahd University of Petroleum and Minerals (KFUPM) is gratefully acknowledged.

### BACKGROUND

### Technical Field

The present disclosure is directed towards electrocatalysts for water splitting systems and, more particularly, to vanadium-doped manganese cobalt spinel oxide based electrocatalysts for generating hydrogen.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

The growing global energy demand and depletion of fossil fuels associated with toxic pollutants and greenhouse gas emissions has stimulated interest in developing a renewable energy technology that may protect the environment and provide enough energy to ensure socio-economic development. Hydrogen is one of the most sustainable and low-cost technologies for large-scale clean energy production. Electrocatalytic water splitting provides a sustained energy source for generating hydrogen/oxygen at a large scale with high purity, high efficiency, and zero pollutants. Several alloys and materials oxides are used for developing water splitting electrodes. However, there remains a need for the development of a suitable catalyst with low cost, natural abundance, excellent electrochemical activity, ease of preparation, and long-term stability for both HER and OER for electrocatalytic water splitting (EWS).

Certain oxides with transition metals, such as spinel structures (AB₂O₄), have high electronic conductivity and exhibit significant electrochemical activity in the hydrogen/oxygen evolution reaction (HER/OER) due to their chemical and physical characteristics. A selection of parameters such as temperature, preparation method, substitution ions, and pH of the precursor solution can affect the catalytic activity of spinels. Accordingly, adjusting the phase of the spinel oxide samples may improve the hydrogen evolution functioning of the sample. The cobalt-based spinel oxides (MnCo₂O₄, NiCo₂O₄, ZnCo₂O₄, CuCo₂O₄) have demonstrated significant performance in electrocatalytic OER. Moreover, MnCo₂O₄ has also been investigated as a potential applicant for energy storage applications, including batteries and supercapacitors, in terms of large capacitance, long cycling stability, and high operating voltage. These electrochemical properties are attributed to the multiple oxidation states (+2, +3, +4) of Mn and Co in magnetic spinel oxides. MnCo₂O₄ has an inverse spinel structure in which Mn²⁺ ions and the Co²⁺ ions have occupied the octahedral (Oh, B) sites and are evenly distributed over the Oh and tetrahedral (Td, A) sites. Cation substitution into MnCo₂O₄ spinel by doping with another element may significantly alter its electrical and magnetic features because the electron transfer distance between B and B is short, which enhances the electron transfer and the electrical conductivity. Therefore, altering the MnCo₂O₄ spinel through doping has potential to improve electrocatalytic activity.

Although several methods have been developed in the past to generate hydrogen, there still exists a need to develop a method for the generation of hydrogen that may circumvent the drawbacks of the prior art. It is one object of the present disclosure to provide a doped MnCo₂O₄ spinel electrocatalyst.

### SUMMARY

In an exemplary embodiment, a method of generating hydrogen is disclosed. The method includes applying a potential of −0.1 volts (V) to −1.0 volt (V) to an electrochemical cell, and the electrochemical cell is at least partially submerged in an aqueous solution. Further, on the application of the potential, the aqueous solution is reduced, thereby forming hydrogen. The electrochemical cell includes an electrocatalyst and a counter electrode. The electrocatalyst includes a substrate and vanadium-doped manganese spinel oxide microspheres (MnVₓCo₂₋ₓO₄) particles. The value of x is ≤0.4, the MnVₓCo₂₋ₓO₄ particles have a spherical shape, the MnVₓCo₂₋ₓO₄ particles have an average diameter of less than 100 nanometers (nm), and the MnVₓCo₂₋ₓO₄ particles are dispersed on the substrate to form the electrocatalyst.

In some embodiments, the MnVₓCo₂₋ₓO₄ particles have an average diameter of 5 nm to 30 nm.

In some embodiments, the MnVₓCo₂₋ₓO₄ particles include 25 weight percentage (wt. %) to 35 wt. % 0, 1 wt. % to 10 wt. % V, 20 wt. % to 30 wt. % Mn, and 40 wt. % to 50 wt. % Co, based on a total weight of the MnVₓCo₂₋ₓO₄ particles.

In some embodiments, the MnVₓCo₂₋ₓO₄ particles are aggregated, forming microspheres.

In some embodiments, the microspheres have an average diameter of 2 micrometers (μm) to 10 μm.

In some embodiments, the MnVₓCo₂₋ₓO₄ particles include less than 5 wt. % MnO₂, based on a total weight of the MnVₓCo₂₋ₓO₄ particles.

In some embodiments, the MnVₓCo₂₋ₓO₄ particles have a cubic crystal structure.

In some embodiments, the MnVₓCo₂₋ₓO₄ particles have a crystallite size of 16 nm to 23 nm.

In some embodiments, the MnVₓCo₂₋ₓO₄ particles have a maximum magnetization value greater than 2.0 electromagnetic units per unit mass (emu/g) at 300 Kelvin (K).

In some embodiments, the MnVₓCo₂₋ₓO₄ particles have a maximum magnetization value greater than 12 emu/g at 10 K.

In some embodiments, the electrocatalyst has an overpotential of less than 250 millivolts (mV) at −10 milliampere per square centimeter (mA/cm²).

In some embodiments, the electrocatalyst includes MnV_{0.3}Co_{1.7}O₄ particles and has an overpotential of 80 mV to 90 mV at −10 mA/cm².

In some embodiments, the electrocatalyst has a Tafel slope of less than 120 mV per decade (mV/dec).

In some embodiments, the electrocatalyst includes MnV_{0.3}Co_{1.7}O₄ particles and has an electrochemical active surface area (ECSA) of greater than 10 cm².

In some embodiments, the substrate is glassy carbon.

In some embodiments, the aqueous solution further includes an acid.

In another exemplary embodiment, a method of preparing the electrocatalyst is described. The method includes mixing urea, a cobalt salt, a manganese salt, and a vanadium salt to form a mixture. The method further includes heating the mixture in an autoclave for at least 6 hours at 150° C. to 250° C. to form the MnVₓCo₂₋ₓO₄ particles, and further coating the MnVₓCo₂₋ₓO₄ particles on the substrate.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof may be readily obtained as the same becomes better understood by reference to the following detailed description when considered in connection with the accompanying drawings, wherein:

FIG. 1 illustrates a flowchart of a method of preparing an electrocatalyst, according to certain embodiments.

FIG. 2 depicts X-ray diffraction spectroscopy (XRD) powder patterns of vanadium-doped MnCo spinel oxide (MnVₓCo₂₋ₓO₄ where x≤0.4) microspheres (MC), represented by Vₓ—MnCo MCs, according to certain embodiments.

FIG. 3A is a scanning electron microscopy (SEM) microstructural image of a Vₓ—MnCo MC sample without V doping (x=0), according to certain embodiments.

FIG. 3B is a SEM microstructural image of Vₓ—MnCo MC sample (x=0.1), at different magnifications, according to certain embodiments.

FIG. 3C is a SEM microstructural image of Vₓ—MnCo MC sample (x=0.2), at different magnifications, according to certain embodiments.

FIG. 3D is a SEM microstructural image of Vₓ—MnCo MC sample (x=0.3), at different magnifications, according to certain embodiments.

FIG. 3E is a SEM microstructural image of Vₓ—MnCo MC sample (x=0.4), at different magnifications, according to certain embodiments.

FIG. 4A is a transmission electron microscopy (TEM) micrograph of the Vₓ—MnCo MC sample (x=0.3), according to certain embodiments.

FIG. 4B is a high-resolution transmission electron microscopy (HRTEM) micrograph of the Vₓ—MnCo MC sample (x=0.3), according to certain embodiments.

FIG. 5A depicts an energy dispersive X-ray (EDX) spectrum of the Vₓ—MnCo MC sample (x=0.2), according to certain embodiments.

FIG. 5B depicts an EDX spectrum of the Vₓ—MnCo MC sample (x=0.4), according to certain embodiments.

FIG. 6A depicts an X-ray photoelectron spectroscopy (XPS) survey scan of the Vₓ—MnCo MC sample (x=0.3), according to certain embodiments.

FIG. 6B depicts an XPS core-level scan for C 1s, according to certain embodiments.

FIG. 6C depicts an XPS core-level scan for Co 2p, according to certain embodiments.

FIG. 6D depicts an XPS core-level scan for Mn 2p, according to certain embodiments.

FIG. 6E depicts an XPS core-level scan for V 2p, according to certain embodiments.

FIG. 6F depicts an XPS core-level scan for O 1s, according to certain embodiments.

FIG. 7A is a magnetic hysteresis loop of the Vₓ—MnCo(x≤0.4) MC sample recorded at a temperature of 300 Kelvin (K), according to certain embodiments.

FIG. 7B is a magnetic hysteresis loop of the Vₓ—MnCo(x≤0.4) MC sample recorded at a temperature of 10 K, according to certain embodiments.

FIG. 8A depicts evolution in coercive field (H_{c}) at 10 K with varying ‘x’ percentage in the Vₓ—MnCo MC samples, according to certain embodiments.

FIG. 8B depicts evolution in remanent magnetization (Mᵣ) at 10 K with varying ‘x’ percentages in the Vₓ—MnCo MC samples, according to certain embodiments.

FIG. 8C depicts evolution in Mₘₐₓ (±70 Kilo Oersted (KOe) at 300 K and 10 K, according to certain embodiments.

FIG. 9 depicts temperature dependence of magnetization (M-T) of Vₓ—MnCo(x≤0.4) MC samples measured under zero-field-cooling (ZFC) and field cooling (FC) conditions and a dc-magnetic field of 100 Oe, according to certain embodiments.

FIG. 10 depicts variations in T_{P} and T_{SP} temperatures versus vanadium content for various Vₓ—MnCo(x≤0.4) MC samples, according to certain embodiments.

FIG. 11A depicts linear sweep voltammetry (LSV) curves of the Vₓ—MnCo(x≤0.4) MC sample, according to certain embodiments.

FIG. 11B depicts a comparison plot between different catalysts of the Vₓ—MnCo MC sample and their respective normalized overpotentials at the current density of 10 mA/cm², according to certain embodiments.

FIG. 11C depicts cyclic voltammetric (CV) curves recorded in non-Ohmic region of −0.25 to −0.35 voltage (V) versus reversible hydrogen electrode (RHE) at different scan rates for the Vₓ—MnCo(x=0.3) MC sample, according to certain embodiments.

FIG. 11D depicts current density versus scan rate plot to estimate a value of Cai for Vₓ—MnCo MC samples, according to certain embodiments.

FIG. 12A depicts Tafel plot for the Vₓ—MnCo(x≤0.4) MC sample, according to certain embodiments.

FIG. 12B is a Nyquist plot for the Vₓ—MnCo MC sample, according to certain embodiments.

FIG. 12C depicts LSV curves of the Vₓ—MnCo(x=0.3) MC sample swept before and after 1000 CV cycles, according to certain embodiments.

FIG. 12D depicts a CV curve of the Vₓ—MnCo(x=0.3) MC sample observed for a prolonged period of 36 hours, according to certain embodiments.

FIG. 13A is an XRD spectrum of the Vₓ—MnCo(x=0.3) MC sample after the stability test, according to certain embodiments.

FIG. 13B shows an EDX spectrum and SEM image of the Vₓ—MnCo(x=0.3) MC sample after the stability test, according to certain embodiments.

### DETAILED DESCRIPTION

When describing the present disclosure, the terms used are to be construed in accordance with the following definitions, unless a context dictates otherwise.

Embodiments of the present invention will now be described more fully hereinafter with reference to the accompanying drawings wherever applicable, in that some, but not all, embodiments of the disclosure are shown.

Where a numerical limit or range is stated herein, the endpoints are included. Also, all values and subranges within a numerical limit or range are specifically included as if explicitly written out.

In the drawings, like reference numerals designate identical or corresponding parts throughout the several views. Further, as used herein, the words “a,” “an” and the like generally carry a meaning of “one or more,” unless stated otherwise.

Furthermore, the terms “approximately”, “approximate”, “about,” and similar terms generally refer to ranges that include the identified value within a margin of 20%, 10%, or preferably 5%, and any values therebetween.

The use of the terms “include,” “includes”, “including,” “have,” “has,” or “having” should be generally understood as open-ended and non-limiting unless specifically stated otherwise.

As used herein, “particle size” and “pore size” may be thought of as the lengths or longest dimensions of a particle and a pore opening, respectively.

As used herein, the term “electrode” refers to an electrical conductor used to contact a non-metallic part of a circuit, e.g., a semiconductor, an electrolyte, a vacuum, or air.

As used herein, the term “current density” refers to the amount of electric current traveling per unit cross-section area.

As used herein, the term “Tafel slope” refers to the relationship between the overpotential and the logarithmic current density.

As used herein, the term “electrochemical cell” refers to a device capable of generating electrical energy from chemical reactions or using electrical energy to cause chemical reactions.

As used herein, the term “water splitting” refers to the chemical reaction in which water is broken down into oxygen and hydrogen as shown below.

2H₂O→2H₂+O₂

As used herein, the term “overpotential” “refers to the difference in potential that exists between a thermodynamically determined reduction potential of a half-reaction and the potential at which the redox event is experimentally observed. The term is directly associated with a cell's voltage efficacy. In an electrolytic cell, the occurrence of overpotential implies that the cell needs more energy than that thermodynamically expected to drive a reaction. The quantity of overpotential is specific to each cell design and varies across cells and operational conditions, even for the same reaction. Overpotential is experimentally measured by determining the potential at which a given current density is reached.

The present disclosure is intended to include all hydration states of a given compound or formula, unless otherwise noted or when heating a material.

As used herein, the terms “electrocatalyst” and “catalyst” are used interchangeably and refer to the catalyst of the invention.

Aspects of the present disclosure are directed to a method for generating hydrogen using a vanadium-doped MnCo spinel oxide-based electrocatalyst (also referred to as an electrocatalyst or catalyst herein). The electrocatalyst is represented by MnVₓCo₂₋ₓO₄ (where x≤0.4) and is evaluated for its potential in hydrogen evolution reaction (HER). The results indicate that the electrocatalyst of the present disclosure demonstrated improved HER performance and outstanding electrocatalytic stability.

The first aspect of the present disclosure is directed to an electrocatalyst including spinel particles. Spinels are any of a class of minerals of general formulation AB₂X₄ which crystallize in the cubic crystal system, with the X anions arranged in a cubic close-packed lattice and the A cations occupy tetrahedral holes, and the B cation occupy octahedral holes. In an embodiment, A is selected from the group consisting of Mg, Zn, Fe, Mn, Cu, Ni, Ti, or Be. In an embodiment, B is selected from the group consisting of Al, Fe, Mn, Cr, and Co. In an embodiment, X is O or S. In a preferred embodiment, the electrocatalyst includes MnCo₂O₄. To alter the structure and electrochemical performance of the MnCo₂O₄, it can be doped with at least one element selected from the group consisting of Al, Ti, V, Cr, Mn, Fe, Co, Ru, and Rh. In a preferred embodiment, the electrocatalyst includes vanadium (V)-doped Mn(manganese) Co(cobalt) oxide particles, also referred to as particles. The particles are represented by the formula MnVₓCo₂₋ₓO₄, where x≤0.4. In an embodiment, x may be 0.1, 0.15, 0.2, 0.25, 0.3, 0.35, or 0.4. In a preferred embodiment, x=0.3. In an embodiment, the particles include at least one of Mn(II), Mn(III), Mn(IV), Mn(V), Mn(VI), and Mn(VII). In an embodiment, the particles include at least one of Co(I), Co(II), Co(III), and Co(IV). In an embodiment, the particles include at least one of V(II), V(III), V(IV), and V(V).

The particles may have many shapes, such as cones, cuboidal, pyramidical, cylindrical, wires, crystals, rectangles, triangles, pentagons, hexagons, prisms, disks, cubes, ribbons, blocks, beads, discs, barrels, granules, whiskers, flakes, foils, powders, boxes, stars, flowers, etc., and mixtures thereof. In a specific embodiment, the particles are spherical with an average diameter of fewer than 100 nanometers (nm). In some embodiments, the particles have an average diameter in the range of 1-90 nm, preferably 2-80 nm, preferably 3-70 nm, preferably 4-60 nm, preferably 5-50 nm, preferably 5-40 nm, and preferably 5-30 nm. In a preferred embodiment, the particles have an average diameter of 10-30 nm. In some embodiments, the particles are aggregated to form microspheres having an average diameter of 2-10 μm, preferably 3-9 μm, 4-8 μm, 5-7 μm or about 6 μm. In an embodiment, the particles have cubic, hexagonal, or monoclinic crystal structure. In a preferred embodiment, the particles have a cubic crystal structure. Wherein a portion, depending on the value of x, of the Co atoms in the cubic crystal structure are replaced with V atoms, thereby forming defects. Although, different oxides may be present, the MnVₓCo₂₋ₓO₄ particles include less than 5 wt. % MnO₂, preferably less than 4 wt. %, 3 wt. %, 2 wt. %, or 1 wt. % based on the total weight of the MnVₓCo₂₋ₓO₄ particles.

The particles are crystalline with crystallite size in the range of 16-23 nm, preferably 16-22.5 nm, 17-22 nm, 18-21 nm, or 19-20 nm. The value of “x” affects the crystallite size of the MnVₓCo₂₋ₓO₄ particles, where x≤0.4. For example, when “x”=0.2, the particles have a crystallite size in the range of 16-23 nm, preferably 17-23 nm, preferably 18-23 nm, preferably 19-23 nm, preferably 20-22.5 nm, and preferably 22.4 nm. When “x”=0.3, the particles have a crystallite size in the range of 16-20 nm, preferably 16.5-19 nm, preferably 16.7-18 nm, preferably 17-17.5 nm, preferably 17.2 nm. Similarly, when “x”=0.4, the particles have a crystallite size in the range of 16-20 nm, preferably 16-19 nm, preferably 16-18 nm, and preferably 16 nm.

The particles include 25-35 wt. %, preferably 26-34 wt. %, preferably 27-32 wt. %, preferably 28-30 wt. %, preferably 28.1 to 29.5 wt. % oxygen (O); 1-10 wt. %, preferably 2-9 wt. %, preferably 3 to 8.75 wt. %, preferably 4-8.5 wt. %, preferably 4.5 to 8.5 wt. % of Vanadium (V); 20-30 wt. %, preferably 20-28 wt. %, preferably 20-25 wt. %, preferably 20-23 wt. %, preferably 20.5 to 22.5 wt. % of Manganese (Mn), and 40-50 wt. %, preferably 40-48 wt. %, preferably 40-46 wt. %, preferably 40-45 wt. %, preferably 41-45 wt. % of Cobalt (Co), based on the total weight of the MnVₓCo₂₋ₓO₄ particles. In an embodiment, the particles include 28.22 wt. % oxygen, 4.54 wt. % vanadium, 22.35 wt. % manganese, and 44.89 wt. % cobalt, based on the total weight of the MnVₓCo₂₋ₓO₄ particles. In some embodiments, the particles include 28.43 wt. % oxygen, 8.36 wt. % vanadium, 20.85 wt. % manganese, and 42.36 wt. % cobalt, based on the total weight of the MnVₓCo₂₋ₓO₄ particles. In certain other embodiments, the particles include 29.4 wt. % oxygen, 7.8 wt. % vanadium, 18.54 wt. % manganese, and 43.71 wt. % cobalt, based on the total weight of the MnVₓCo₂₋ₓO₄ particles.

The MnVₓCo₂₋ₓO₄ particles have a maximum magnetization value greater than 2.0 emu/g, preferably 2.0-3.5 emu/g, 2.2-3.2 emu/g, 2.4-3.0 emu/g, or 2.6-2.8 emu/g at 300 K and a maximum magnetization value greater than 12 emu/g, preferably 12-20 emu/g, 13-19 emu/g, 14-18 emu/g, or 15-17 emu/g at 10 K. The magnetic susceptibilities may be measured with a laboratory magnetometer such as a vibrating sample magnetometer, a superconducting quantum interference device, inductive pickup coils, a pulsed field extraction magnetometer, a torque magnetometer, a faraday force magnetometer, and an optical magnetometer. The magnetization values continuously increase with vanadium substitution.

The particles are dispersed on the substrate to form the electrocatalyst. The particles may form a continuous layer on the substrate. The particles cover at least 50%, preferably 55%, preferably 60%, preferably 65%, preferably 70%, preferably 75%, preferably 80%, preferably 85%, preferably 90%, and preferably >95% of the substrate. The substrate is an electrically conductive material such as, but not limited to, glassy carbon, graphite, gold, platinum, silver, iron, copper, aluminum, and the like. In a preferred embodiment, the substrate is glassy carbon. The substrate may have a thickness in a range of about 10 micrometers (μm) to 140 μm, for example, ranging from about 20 μm to about 120 μm, from about 50 μm to about 100 μm, from about 70 μm to about 95 μm, or from about 85 μm to about 90 μm, including all ranges and sub-ranges therebetween.

A method of generating hydrogen is described. The method includes applying a potential of −0.1 to −1.0 V, preferably −0.2 to −0.9 V, −0.3 to −0.8 V, −0.4 to −0.7 V, and −0.5 to −0.6 V to an electrochemical cell. The electrochemical cell includes the above described electrocatalyst (anode) and a counter electrode (cathode). The counter electrode may contain an electrically-conductive material such as platinum, platinum-iridium alloy, iridium, titanium, titanium alloy, stainless steel, gold, cobalt alloy, and some other electrically-conductive material, where an “electrically-conductive material” as defined here is a substance with an electrical resistivity of at most 10⁻⁶ ohms meter (Ω·m), preferably at most 10⁻⁷ Ω·m, more preferably at most 10⁻⁸ Ω·m at a temperature of 20-25° C. In a preferred embodiment, the counter electrode includes any material which is capable of undergoing oxygen evolution reaction (OER). The counter electrode is complementary to the electrocatalyst of the present disclosure which undergoes the hydrogen evolution reaction (HER) in water splitting.

The form of the counter electrode may be generally relevant only in that it needs to supply sufficient current to the electrolyte solution to support the current required for the electrochemical reaction of interest. The material of the counter electrode should thus be sufficiently inert to withstand the chemical conditions in the electrolyte solution, such as acidic or basic pH values, without substantially degrading during the electrochemical reaction. The counter electrode should preferably not leach out any chemical substance that interferes with the electrochemical reaction or might lead to undesirable electrode contamination. In some embodiments, the counter electrode is a platinum electrode, more specifically, a platinum wire. In a specific embodiment, the electrocatalyst forms the working electrode (anode), and a platinum wire forms the counter electrode for hydrogen generation.

In one embodiment, the counter electrode may be a wire, a rod, a cylinder, a tube, a scroll, a sheet, a piece of foil, a woven mesh, a perforated sheet, or a brush. The counter electrode material should thus be sufficiently inert to withstand the chemical conditions in the electrolyte solution, such as acidic or basic pH values, without substantially degrading during the electrochemical reaction. The counter electrode should preferably not leach out any chemical substance that interferes with the electrochemical reaction or might lead to undesirable electrode contamination.

In one embodiment, the electrochemical cell further includes a reference electrode in contact with the electrolyte solution. A reference electrode is an electrode that has a stable and well-known electrode potential. The high stability of the electrode potential is usually reached by employing a redox system with constant (buffered or saturated) concentrations of each relevant species of the redox reaction. A reference electrode may enable a potentiostat to deliver a stable voltage to the working or counter electrodes. The reference electrode may be RHE, a standard hydrogen electrode (SHE), a normal hydrogen electrode (NHE), a saturated calomel electrode (SCE), a Cu—Cu(II) sulfate electrode (CSE), a silver chloride electrode (Ag/AgCl), a pH-electrode, a palladium-hydrogen electrode, a dynamic hydrogen electrode (DHE), a mercury-mercurous sulfate electrode, or some other type of electrode. In a preferred embodiment, the reference electrode is Ag/AgCl.

The electrochemical cell is at least partially submerged in an aqueous solution, preferably 50%, preferably 60%, or more preferably at least 70%, 80%, or 100%. The aqueous solution includes water and an acid. The water may be tap water, distilled water, bidistilled water, deionized water, deionized distilled water, reverse osmosis water, and/or some other water. Preferably, at 25° C., the water has an electrical conductivity at less than 10 micro siemens per centimeter (μS·cm⁻¹), preferably less than 2 μS·cm⁻¹. The acid is at least one selected from sulfuric acid, hydrochloric acid, nitric acid, phosphoric acid, hydrofluoric acid, boric acid, perchloric acid, carbonic acid, acetic acid, formic acid, hydrobromic acid, sulfamic acid, hypochlorous acid, sulfurous acid, hydroiodic acid, hypophosphorous acid, phosphorous acid, fumaric acid, iodic acid, chromic acid, chloric acid, hydrogen cyanide, nitroxyl, oxalic acid, etc. In a preferred embodiment, the acid is sulfuric acid. The concentration of the acid in the aqueous solution is in a range of 0.1 to 5 M, preferably 0.2-3 M, preferably 0.3-1 M, preferably 0.4 M-0.7 M, preferably 0.5 M. On applying the potential water in the aqueous solution is reduced thereby forming hydrogen.

The electrocatalyst of the present disclosure may also be used in water-splitting reactions. In some embodiments, the electrocatalyst may also be used in the field of batteries, fuel cells, photochemical cells, water splitting cells, electronics, water purification, hydrogen sensors, semiconductors (such as field-effect transistors), magnetic semiconductors, capacitors, data storage devices, biosensors (such as redox protein sensors), photovoltaics, liquid crystal screens, plasma screens, touch screens, OLEDs, antistatic deposits, optical coatings, reflective coverings, anti-reflection coatings, and/or reaction catalysis.

The electrocatalyst when including MnVₓCo₂₋ₓO₄ particles, where x≤0.4, have an overpotential of less than 250 millivolts (mV) at −10 mA/cm², preferably 75-250 mV, 100-225 mV, 125-200 mV, or 150-175 mV and a Tafel slope of less than 120 mV per decade, preferably 80-120, 85-115, 90-110, 95-105 mV per decade. In a specific embodiment, when the electrocatalyst includes the MnVₓCo₂₋ₓO₄ particles, where x is 0.3, it has an overpotential of 80-90 mV, preferably 82-88, preferably 84-86, preferably 85.9 mV at −10 mA/cm², and a Tafel slope of 80-90, preferably 82-88, preferably 83-85, preferably 84 mV per decade.

In some embodiments, the electrocatalyst has an electrochemical active surface area (ECSA) of 7-12 cm², preferably 8-11 cm², or 9-10 cm². In a preferred embodiment, when the electrocatalyst includes MnVₓCo₂₋ₓO₄ particles, where x is 0.3, the ECSA is greater than 10 cm², preferably between 10-15, 11-13, preferably 11.4 cm².

While not wishing to be bound to a single theory, it is thought that the improved HER performance of the MnVₓCo₂₋ₓO₄ particles, is attributed to the V doping which provides a unique morphology, increases the electrochemical surface area, and results in many defective sites, which are advantageous for the rapid transfer of charges.

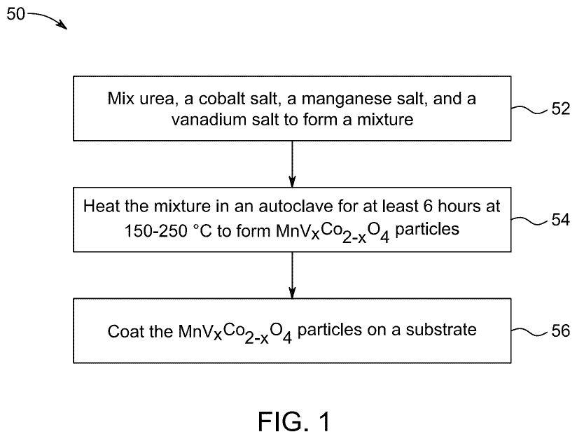

FIG. 1 illustrates a flow chart of a method 50 of preparing an electrocatalyst. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes mixing urea, a cobalt salt, a manganese salt, and a vanadium salt to form a mixture. The mixing may be carried out manually or with the help of a stirrer. Suitable examples of the cobalt salt include Co(NO₃)₂, CoCl₂, CoBr₂, CoIₑ, CoF₂, CoS, CoSO₄, cobalt(II) acetate, tris(ethylenediamine)cobalt(III) chloride ([Co(en)₃]Cl₃), [Co(NH₃)₆]Cl₃, tris(triphenylphosphine)cobalt(I) chloride ((P(CH₅)₃)₃CoCl), Co₂O₃ (cobalt(III) oxide), Co₂O (cobalt(II) oxide), CoFe₂O₄, or some other cobalt salt or cobalt-containing compound. Preferably, the cobalt has a +2 oxidation state, though in an alternative embodiment, cobalt having a different oxidation state, such as +3, may be used. In one embodiment, the cobalt of the cobalt salt consists essentially of cobalt in a +2 oxidation state. As defined here, the cobalt “consisting essentially of cobalt in a +2-oxidation state” means that at least 95 wt. %, preferably at least 99.wt %, more preferably at least 99.5 wt. % of the cobalt, has a +2 oxidation state relative to the total weight of the cobalt. Preferably, the cobalt salt may be in any hydration state; for instance, Co(NO₃)₂ includes both Co(NO₃)₂ and Co(NO₃)₂·6H₂O. In a preferred embodiment, the cobalt salt is Co(NO₃)₂·6H₂O. Suitable examples of manganese salt include manganese nitrate, manganese sulfate, MnX₂ (where X is F, Cl, Br, or I), manganese hydroxide, manganese molybdate, manganese phosphate, and similar inorganic compounds. Preferably, the manganese salt may be in any hydration state; for instance, Mn(NO₃)₂ includes both Mn(NO₃)₂ and Mn(NO₃)₂·6H₂O. In a preferred embodiment, the manganese salt is Mn(NO₃)₂·6H₂O. The vanadium salt is vanadium halide, preferably vanadium chloride (VCl₃). Optionally, other vanadium salts, such as vanadium pentoxide, vanadyl sulfate, and vanadyl acetylacetone, may be used as well, alone or in combination with other known vanadium salts. Stoichiometric amounts of urea, the cobalt salt, the manganese salt, and the vanadium salt may be mixed in a solvent. The solvent may be organic or inorganic. In a preferred embodiment, the solvent is inorganic, preferably water.

At step 54, the method 50 includes heating the mixture in an autoclave for at least 6 hours at 150-250° C. to form the MnVₓCo₂₋ₓO₄ particles. The MnVₓCo₂₋ₓO₄ particles are produced by any well-known process known to the skilled artisan in the relevant field. Examples of suitable processes for producing the metal oxide of the present disclosure include, but are not limited to, hydrothermal, sol-gel, solid-state reaction, high energy ball miffing, co-sedimentation, and the like. As outlined in the working examples, hydrothermal reaction is adopted to produce the metal oxide composite of the present disclosure, in which the hydrothermal reaction is conducted at a temperature between 25-300° C., such as at the temperature of 25, 50, 100, 110, 120, 130, 140, 150, 160, 170, 180, 190, 200, 210, 220, 230, 240 or 250° C., preferably 180° C. for 1-15 hours, preferably 1,2,3,4,5,6,7,8,9,10,11,12,13,14, preferably 12 hours. In an embodiment, the hydrothermal reaction occurs at 180° C. for 12 hours to form the MnVₓCo₂₋ₓO₄ particles. In some embodiments, the heating may be carried out via any other heating appliances such as ovens, microwaves, hot plates, heating mantles and tapes, oil baths, salt baths, sand baths, air baths, hot-tube furnaces, and hot-air guns. The MnVₓCo₂₋ₓO₄ particles may be washed further to remove unreacted reactants/impurities and dried in an oven.

At step 56, the method 50 includes coating the MnVₓCo₂₋ₓO₄ particles on the substrate. The substrate may be coated by any conventional techniques known in the art, for example, drop-casting, dipping, spraying, coating, etc.

### Examples

The following details of the examples demonstrate a method for generating hydrogen as described herein. The examples are provided solely for illustration and are not to be construed as limitations of the present disclosure, as many variations thereof are possible without departing from the spirit and scope of the present disclosure.

### Example 1: Synthesis of Mn Spinel Oxide Microspheres (Vₓ—MnCo MCs) and Electrode Preparation

A one-step hydrothermal process is used to manufacture the MnVₓCo₂₋ₓO₄ microspheres, labeled as Vₓ—MnCo(x≤0.4) MCs. Different amounts of the vanadium is doped into the MnVₓCo₂₋ₓO₄, where x=0.0, 0.1, 0.2, 0.3, and 0.4. Stoichiometric amount of Co(NO₃)₂·6H₂O, Mn(NO₃)₂·6H₂O, VCl₃, and urea (CH₄N₂O) were used as initial materials. The stoichiometric quantities of metal salts were dissolved in 20 milliliters (ml) of de-ionized water (DI H₂O) by stirring at room temperature (RT), and then 1.2 g of CH₄N₂O was dissolved in 30 ml of DI water. Both mixtures were stirred and sonicated for 30 minutes. The solution was poured into an autoclave made of stainless steel and heated for 12 hours (h) at 180° C. Finally, the solid product was washed with warm DI H₂O, filtered, and dried in an oven.

For the working electrode preparation, 80 microlitres (μL) of 5% Nafion solution and 4 mg of catalyst were dissolved in a mixture of DI H₂O and ethanol in 1 ml (4:1 in volume ratio). Ultrasonication was utilized for 30 minutes to guarantee that the solution was fully dispersed. Then, 5 μL catalyst ink solution was deposited on a polished GC electrode and dried at 80° C. for 2 h to achieve the catalyst loading of 0.285 mg/cm². The crystal structure of the synthesized MCs was analyzed via a Rigaku Benchtop Miniflex X-ray diffractometer (XRD) (manufactured by Rigaku, Japan). The surface morphology and chemical composition were investigated with scanning electron microscopy (SEM) and FEI with the Titan ST model high-resolution transmission electron microscopy (HRTEM) and transmission electron microscopy (TEM) along with energy dispersive X-ray spectroscopy (EDX).

### Example 2: Electrochemical Characterization Techniques

The linear sweep voltammetry (LSV), cyclic voltammetry (CV), chronopotentiometry (CP), and electrochemical impedance spectroscopy (EIS) were performed in a 0.5 molar (M) sulphuric acid (H₂SO₄) solution with a typical three-electrode system using an AutoLab PGSTAT302N electrochemical workstation. Glassy carbon (GC) electrodes coated with Vₓ—MnCo MCs were used as working electrodes, a saturated Ag/AgCl electrode was employed as the reference electrode, and the Pt wire was utilized as the counter electrode. Nernst equation was used to calibrate all the potentials to reversible hydrogen electrode potential (E_{RHE}), and E_{RHE} was used to calibrate all the potentials for hydrogen evolution reaction (HER) measurements using the following equation,

$${E}_{RHE} = {E}_{app 1} + 0.059 pH + {E}_{Ag / AgCl}^{o}$$

where E°_{Ag/AgCl} is the standard electrode potential equivalent to 0.198 V at 25° C. The scan rate for LSV measurements was 5 mV·s⁻¹. The electrochemical chronopotentiometry was used to measure the stability of the Vₓ—MnCo MCs at a fixed current of −10 mA/cm². EIS measurements were measured by the same potentiostat (PGSTAT302N Autolab), equipped with a frequency module analyzer (FRA₂).

### Example 3: Structural Characterization

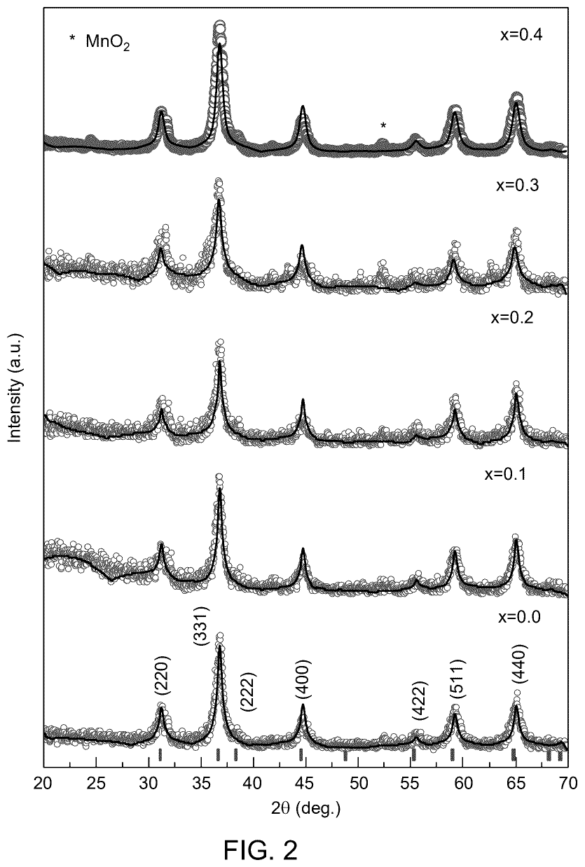

The phase purity analysis of Vₓ—MnCo MCs was investigated through powdered XRD analysis and refined by Match! Software, as depicted in FIG. 2. The XRD pattern disclosed the prominent dominant peaks of cubic spinel oxide structure with relatively low-intensity peaks associated with the trace of MnO₂. All diffraction peaks in FIG. 2 matched well with the standard international centre for diffraction data of MnCo₂O₄. Rietveld analysis of experimental XRD pattern data revealed the lattice parameters, cell volume, reliability factors, and crystallite size, is shown in Table 1. The lattice parameters increased with increasing the ‘x’ due to the expansion in the lattice due to a mismatch in ionic radii. The crystallite sizes were calculated between 16.0 nm and 22.4 nm, implementing Scherrer's formula for the most intense peak.

TABLE 1
Refined cell parameters of Vₓ—MnCo (x ≤ 0.4) MCs.

| x | a = b = c (Å) | V (Å3) | D_{XRD} (nm) ± 0.10 | χ² (chi²) | R_{Bragg} |
|---|---|---|---|---|---|
| 0.0 | 8.1041 | 532.25 | 19.3 | 1.2 | 21.1 |
| 0.1 | 8.1051 | 532.43 | 21.1 | 0.8 | 27.1 |
| 0.2 | 8.1183 | 535.05 | 22.4 | 0.5 | 29.5 |
| 0.3 | 8.1192 | 535.22 | 17.2 | 1.3 | 30.3 |
| 0.4 | 8.1278 | 536.92 | 16.0 | 1.3 | 29.3 |

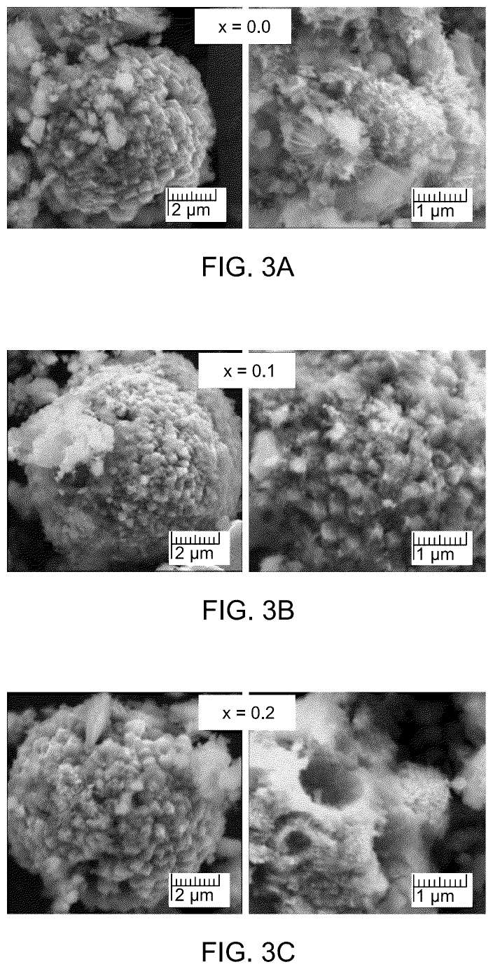

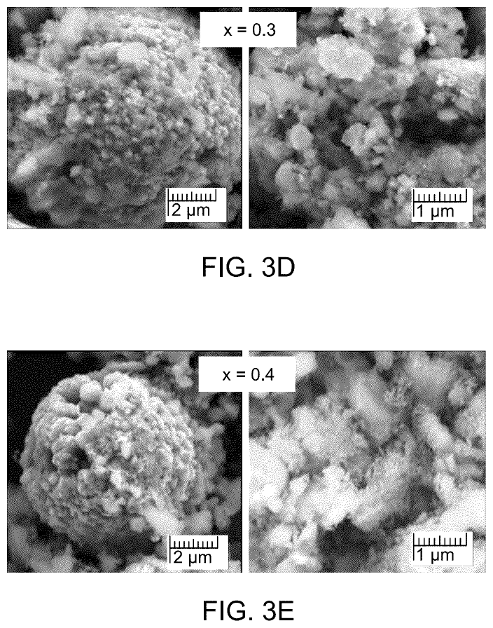

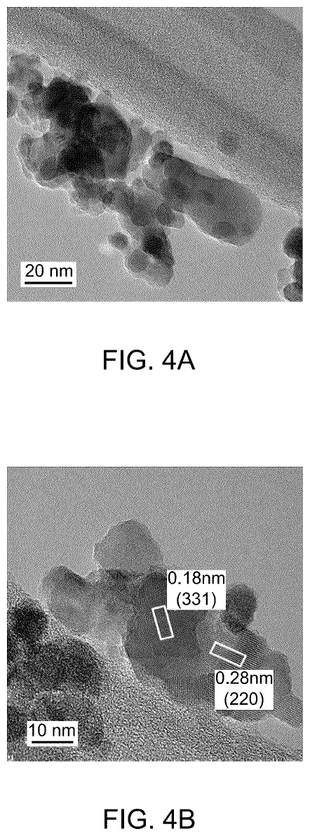

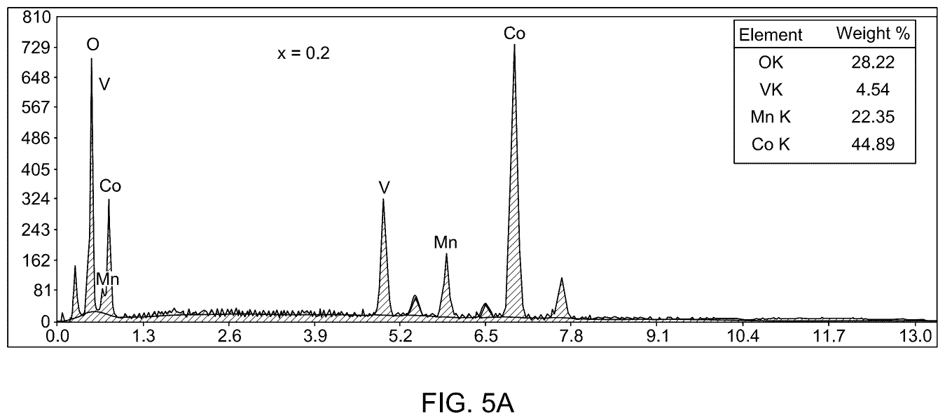

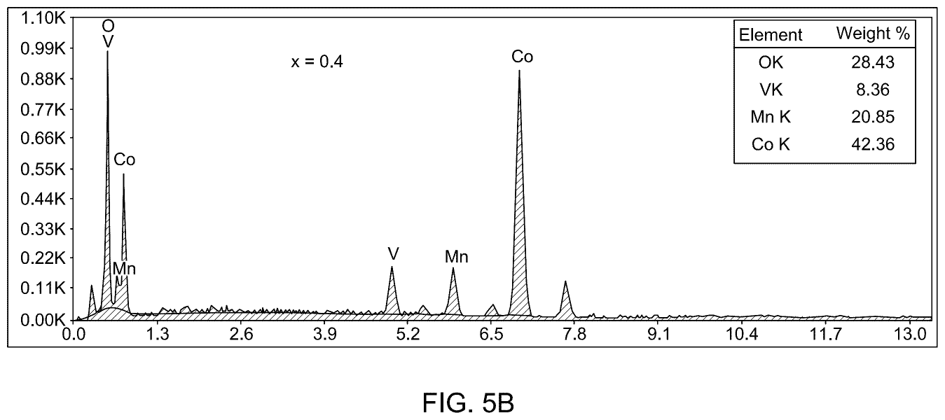

The surface morphology and shape of Vₓ—MnCo MCs were investigated by scanning electron microscopy (SEM) analysis with different magnifications, as depicted in FIGS. 3A-3E. The images exhibited the different sizes of spherical particles. The high magnification images revealed that the spherical particles comprised highly agglomerated small cubic particles, giving rise to the spherical particles with a rough surface. To further confirm the morphology and structure of Vₓ—MnCo MCs (x=0.3), TEM and HR-TEM were employed, as can be seen in FIG. 4A and FIG. 4B, respectively. The assembling of spherical particles can be observed in FIG. 4A, and HR-TEM approved the spinel phase of the Vₓ—MnCo MCs (x=0.3) sample (FIG. 4B). Following the XRD results, the well-defined D-spacing of 0.28 and 0.18 nm are assigned to the (220) and (331) facets of Vₓ MnCo MCs. The presence of Co, Mn, V, and O elements in Vₓ MnCo(x=0.2 and 0.4) MCs was confirmed by the EDX analysis, as illustrated in FIG. 4A and FIG. 4B. The V content was increased, and Mn and Co concentration was suppressed in the EDX spectra from x=0.2 (FIG. 5A) and x=0.4 (FIG. 5B), indicating that V was successfully doped into MnCo MCs and is consistent with XRD and TEM analysis.

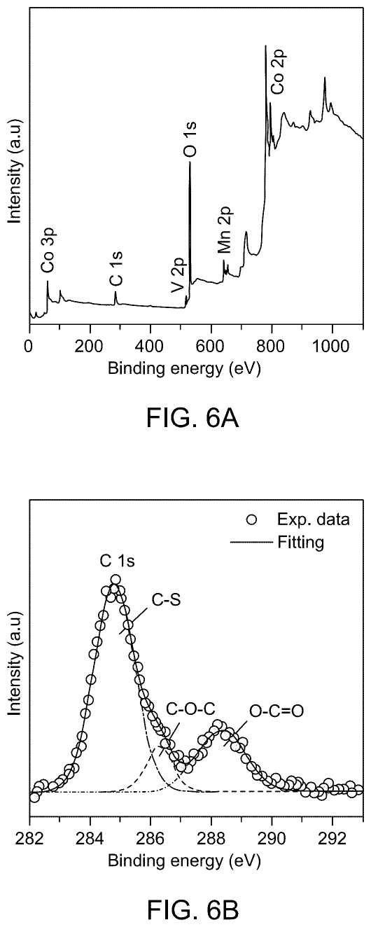

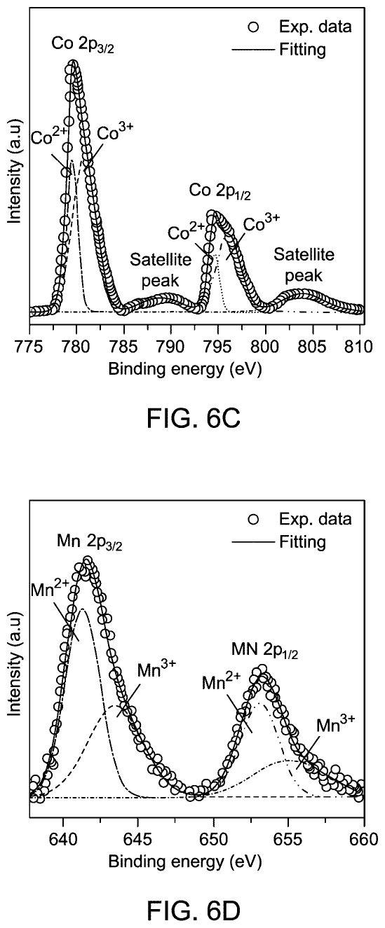

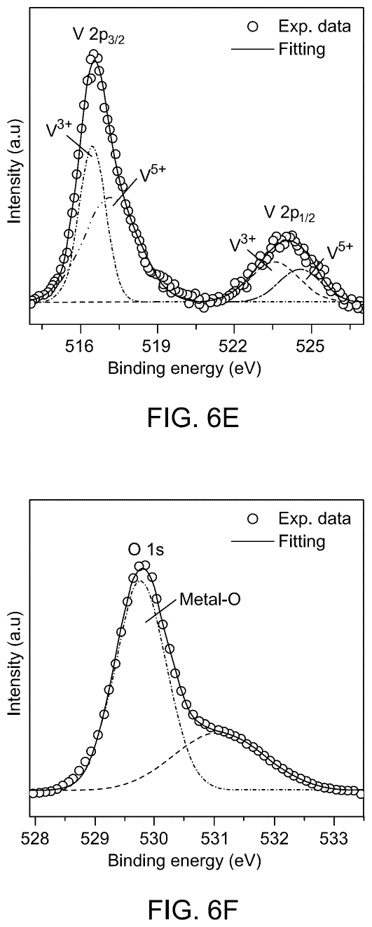

The chemical composition and oxidation state of Vₓ—MnCo MCs (x=0.3) magnetic nanoparticles were determined using XPS analysis. A comprehensive survey scan was conducted to identify the sample elements, as presented in FIG. 6A. In addition, the deconvoluted characteristic peaks of each element are depicted in FIGS. 6B-6F, respectively. The core level spectrum of the C 1s state was observed at 284.8 electron volts (eV), further deconvoluted into three characteristic peaks, as depicted in FIG. 6B. The peaks observed at binding energies of 284.8 eV, 286.3 eV, and 288.3 eV are assigned to C—C, C—O—C, and O—C═O bonds, respectively. FIG. 6C shows the core level peaks of Co at a binding energy of 779.7 eV and 794.7 eV, which correspond to Co 2p_{3/2} and Co 2p_{1/2}, respectively. The deconvolution of the core peak of Co 2p_{3/2} introduced two characteristic peaks at 779.5 eV and 780.9 eV, corresponding to Co²⁺ and Co³⁺ states, respectively. Similarly, the Co 2p_{1/2} spectrum was deconvoluted into two peaks at 794.5 eV and 795.9 eV, indicating the presence of Co atoms at two different geometrical positions in the spinal structure. In addition, two satellite peaks of Co 2p_{3/2} and Co 2p_{1/2} spectra were also observed at 789.0 eV and 804.0 eV, respectively. Mn 2p_{3/2} and Mn 2p_{1/2} core spectra were observed at 641.6 eV and 653.2 eV, respectively, as depicted in FIG. 6D. Due to deconvolution, the core spectra of Mn were split into characteristic peaks associated with Mn²⁺ and Mn³⁺ states, respectively. The spin-orbit doublet of core level spectra of V 2p_{3/2} and V 2p_{1/2} were detected at 516.5 eV and 524.1 eV, respectively, as depicted in FIG. 6E. Furthermore, the deconvolution of the V 2p core spectrum introduces two peaks in each case, indicating the presence of V³⁺ and V⁵⁺ ionic states. FIG. 6F depicts the deconvoluted spectrum of O 1s species exhibiting characteristic peaks at 529.7 eV and 531.1 eV, respectively. The high-intensity peak at 529.7 eV represents the metal oxide bonding, whereas the low-intensity broad peak centered around 531.2 eV is associated with the adsorbed hydroxyl groups and unreacted carbonates.

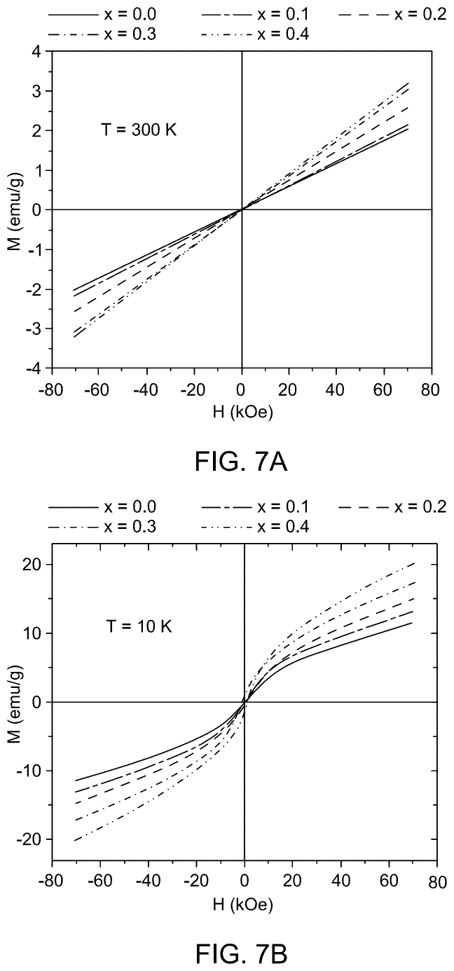

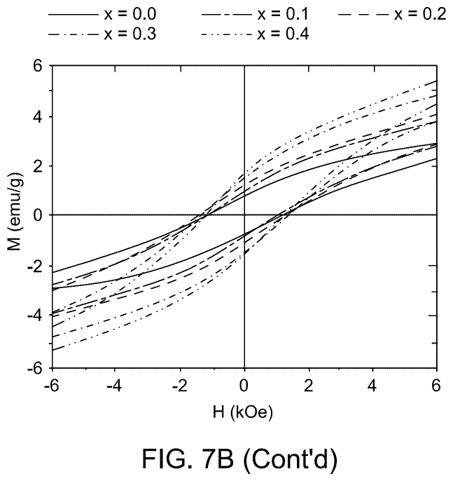

FIG. 7A and FIG. 7B depicts the variations of magnetization against the applied magnetic field (M-H) for different Vₓ—MnCo(x≤0.4) MCs registered under H=±70 kOe and at temperatures of 300 Kelvin (K) and 10 K, respectively. M-H results measured at room temperature showed almost linear curves for all samples, indicating their paramagnetic behavior at 300 K. An apparent hysteresis loop-like feature may be observed in the M-H curves at low magnetic fields measured at 10 K, as pointed out by the enlarged view in the inset of FIG. 7B. The opened hysteresis loops at 10 K for all prepared samples reflect the transformation to a ferrimagnetic state at lower temperatures. In spinel oxides, three main magnetic interactions exist among the tetrahedral (A) and octahedral (B) sites via the intermediate O²⁻ ions through super-exchange interactions. For instance, the weak super-exchange interactions Co²⁺—O²⁻—Co³⁺—O²—Co²⁺ maintained an anti-ferromagnetism effect in Co₃O₄ composition. Substituting some Co³⁺ ions with Mn³⁺ ions to form a MnCo₂O₄ sample may affect the magnetic exchange interactions. Indeed, the inclusion of Mn³⁺ ions having a larger size than Co³⁺ ions may distort the oxygen octahedron and hence frustrate the tetrahedral site, provoking an insufficient magnetic ordering in the MnCo₂O₄ (x=0.0 in this case) MCs. Accordingly, the manifestation of ferrimagnetism in MnCo₂O₄ MCs at lower temperatures may be ascribed to the canting effect of antiferromagnetically ordered spins via structural distortions and breakdown of the equilibrium among the Co²⁺ sublattices' antiparallel magnetization caused by the inclusion of Mn³⁺ ions.

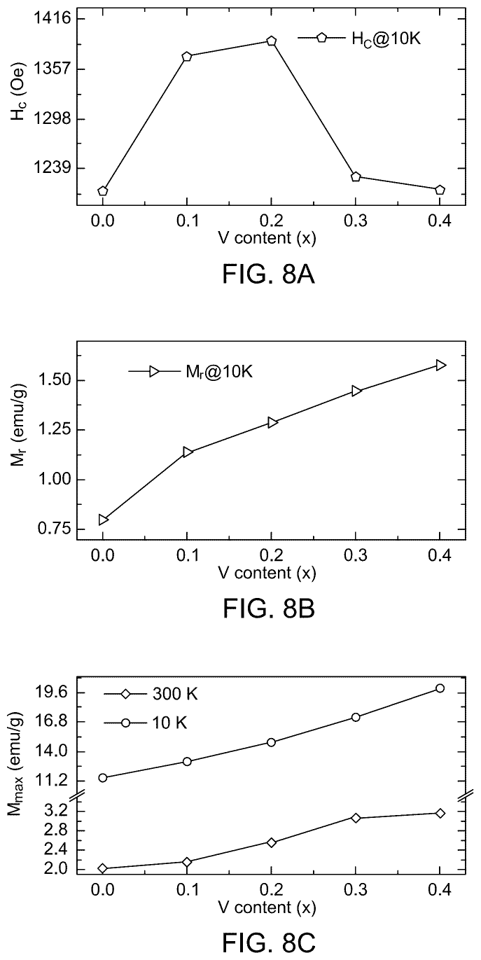

Catalysis and magnetism may be different manifestations of some more fundamental atomic properties. However, the current chief applications of magnetism to catalysis are in structural studies of catalytic solids. On the other hand, the variation in magnetic parameters is a result of the inclusion of vanadium ions that may cause inhomogeneity and intrinsic pinning of the domain walls. Due to the dissimilarity in ionic radii of vanadium and cobalt ions, a change in the exchange interactions may be caused by the local crystal fields. Such an effect may generate energy barriers that may considerably affect the magnetization reversal process at low temperatures. At low temperatures (10 K), the vanadium composition dependence of the magnetic parameters like coercive field (H_{c}), remanent magnetization (Mᵣ), and magnetization Mₘₐₓ achieved at 70 kOe is presented in FIGS. 8A-8C, respectively. The room temperature (300 K) magnetization Mₘₐₓ achieved at 70 kOe was also presented in FIG. 8C. There is a continuous increase in the magnetization Mₘₐₓ with increasing vanadium content in comparison to the parent sample at both 300 and 10 K. For different prepared compositions, Mₘₐₓ (at 70 kOe) increased as the temperature decreased from 300 K down to 10 K. For example, Mₘₐₓ (at 70 kOe) is equal to 2.0 emu/g and 3.2 emu/g at 300 K for samples with x=0.0 and 0.4, respectively, and increased to about 11.5 and 20.0 emu/g at 10 K. As the temperature decreases, Mₘₐₓ (at 70 kOe) increases since the thermal fluctuations contributing to demagnetization with be lowered at lower temperatures. Hence, Mₘₐₓ (at 70 kOe) and Mᵣ and H_{c} rise. In other words, the thermal agitation may decrease as the temperature decreases. Hence, the easy magnetization rotation may be more dominant than the thermal agitations, increasing global magnetization magnitude. As the composition content (x) rises, it is found that Mₘₐₓ (at 70 kOe) and Mᵣ values increase simultaneously at low temperatures (T=10 K). For example, Mₘₐₓ (at ±70 kOe) is about 2.3 emu/g at 300 K and 11.5 emu/g at 10 K for the non-doped sample (x=0.0) and attained about 3.2 emu/g at 300 K and 20.0 emu/g at 10 K for the product with x=0.4. Mᵣ measured at 10 K is about 0.8 emu/g for the non-doped sample (x=0.0) and attained about 1.58 emu/g for the product with x=0.4. For the intermediate compositions, M, values are about 13.1 emu/g, 14.9, and 17.3 emu/g for samples with x=0.1, 0.2, and 0.3, as shown in FIG. 8B, respectively.

The magnetization values continuously increase with vanadium substitution. However, the variation in the H_{c} value showed an anomaly at x>0.2. The H_{c} increases first with increasing vanadium content (x) up to 0.2 but then drops with additional rising vanadium content (x>0.2), as shown in FIG. 8A. The coercivity H_{c} dramatically depends on the crystallite size. According to XRD results, it is found that the crystallite size increases with increasing x content up to 0.2 but falls with further increasing x content. At 10 K, H_{c} is about 1212.1 Oe for the non-doped sample (x=0.0), which progressively increases up to 1371.6 and 1390.3 Oe for the products with x=0.1 and 0.2, respectively, and starts to slightly decrease with the further increase in vanadium content (H_{c}=1230.2 Oe for x=0.3 and H_{c}=1214.5 Oe for x=0.4). The registered H_{c} values are non-negligible, indicating the complex magnetic features of the present samples at low temperatures. The variations in Mₘₐₓ (at 70 kOe) is due to the distribution of cations in different sites and, hence, the variation in the net magnetic moment of the whole system.

For non-substituted MnCo₂O₄ MCs, the cations are distributed among Td and Oh sites as follows: (Co³⁺⁾A[Co²⁺Mn³⁺]_{B}O₄. The Td sites are occupied by Co³⁺ ions (spin S=2 and g=2) with a magnetic moment of about closeμ(A)=4.9μ_{B}. Conversely, the Oh sites are occupied by Co²⁺ and Mn³⁺ ions with high spin state S=3/2 and 2, respectively. Hence, the magnetic moment of B site is equal to, and may be expressed as,

$$μ ( B ) = \sqrt{{( {μ}_{Co}^{2 +} )}^{2} + {( {μ}_{{Mn}^{2 +}} )}^{2}} = \sqrt{{( 3.87 )}^{2} + {( 4.9 )}^{2}} = 6.24 {μ}_{B}$$

Accordingly, the orbital angular momentum of the magnetic ions situated at B sites is completely quenched. Upon vanadium doping, the cations are distributed as (Co³⁺)_{A}[Co₂₋ₓ²⁺Vₓ²⁺Mn³⁺]_{B}O₄, where vanadium ions occupy Oh sites once they substitute some ions of Co²⁺. In this configuration, the three ions residing in the B site display magnetic moments of μ(Co²⁺)=3.87μ_{B},μ(V²⁺)=1.73μ_{B}, and μ(Mn²⁺)=4.9μ_{B}. Substituting some magnetic Co²⁺ ions residing in B sites with some V²⁺ ions with lower magnetic moments may reduce the magnetic moment of B sites. Theoretically, the net magnetic moment of the whole system may decrease with increasing x content since the magnetic moment of A sites is constant. However, in the present disclosure, an increment in magnetization with vanadium substitution has been observed. This indicates that other factors govern the magnetic behavior of present samples.

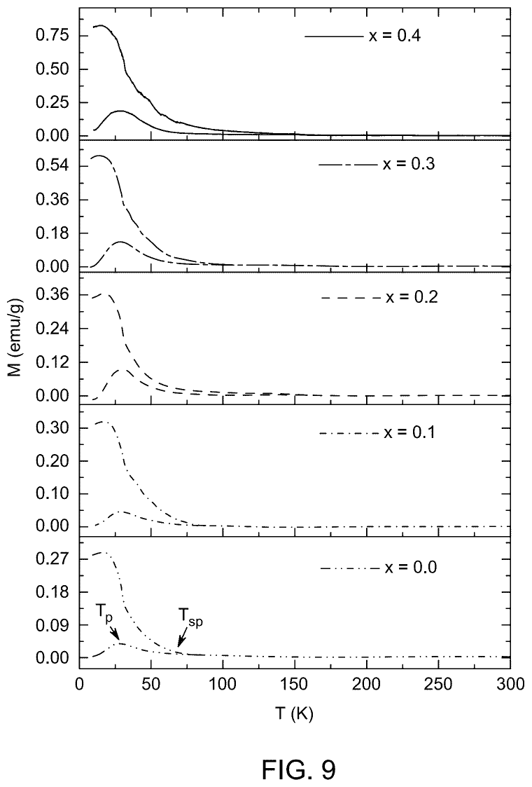

FIG. 9 depicts the temperature (10 K≤T≤325 K) dependence of magnetization (M-T) for different Vₓ—MnCo(x≤0.4) MCs carried out under FC and ZFC conditions. A dc-magnetic field of about Hₐₚₚ=100 Oe was applied. M-T curves measured under ZFC and FC conditions were noted as M_{ZFC}(T) and M_{FC}(T) curves, respectively. The general shape of M_{ZFC}(T) curves is practically comparable for different products. The marked transformation in the slope of both M_{ZFC}(T) and M_{FC}(T) plots indicates the ferrimagnetic Curie temperature T_{c}. These magnetic transitions at T_{c} emphasize the ferrimagnetic behavior of the prepared products. For Vₓ—MnCo(x≤0.4) MCs, T_{c} values are lesser than those registered for bulk MnCo₂O₄ MCs (Tc˜185 K), which is mainly attributed to the effects of finite size. The Vₓ—MnCo(x≤0.4) MCs display a distinctive separation between the M_{ZFC}(T) and M_{FC}(T) curves at a specific temperature noted as T_{SP}<T_{C}, as can be seen from FIG. 9. The M_{FC} (T) plot declines progressively with the rising temperature and merges more than the M_{ZFC}(T) plot. The thermal irreversibility of magnetization is usually detected under Curie temperature. This is because of high magneto crystalline anisotropy in prepared samples.

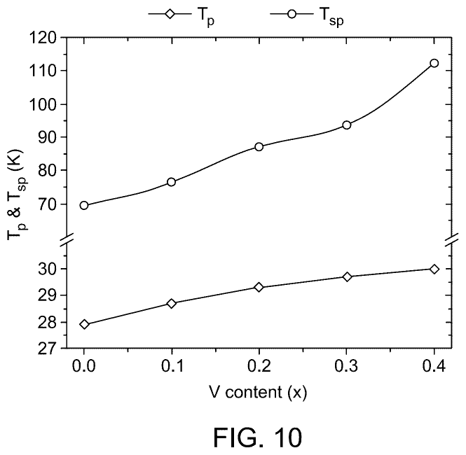

Furthermore, all products showed maximum magnetizations peak at a temperature noted as T_{P} (lower than the Curie temperature) in the M_{ZFC}(T) curves, and afterward, it falls to shallow values. The appearance of a peak around T_{P} is ascribed to either the spin-glass state or the blocking phenomenon caused by the finite sizes and surficial effects in Vₓ—MnCo(x≤0.4) MCs. Moreover, the presence of such a peak is explained based on the Hopkinson effect, a competing effect between the applied magnetic field and the magneto-crystalline anisotropy that varies with the temperature. Like what was reported in the above M-H part, the impact of domain wall pinning may also influence the shape of M_{ZFC}(T) curves. Indeed, by heating the specimen with a low magnetic field application, the domain walls' mobility are raised. This means that the domain wall pinning effect is diminished with the increase in temperature. Hence, the walls are moved easily toward the direction of the applied magnetic field, which provoke a small increment in the magnetization. Above T_{C}, the product is demagnetized; hence, the magnetization drops to almost zero at T_{C}. On the other hand, the thermal agitation tends to increase as the temperature increases, leading to a reduction in magnetization. Nevertheless, at T<T_{C}, the rotation of easy magnetization may be more dominant than the thermal agitations, leading to a global rise in magnetization. Consequently, a maximum peak is detected in the M_{ZFC}(T) curves below T_{C}. Furthermore, it was evident that T_{C} shifts progressively towards higher temperatures with increasing ‘x.’ This is correlated with the slight increment of crystallite/grain size as the vanadium content increases. The variations in the critical temperatures of T_{SP} and T_{P} as a function of vanadium content are shown in FIG. 10. It is noticed that T_{P} and T_{SP} shift gradually towards higher temperatures with increasing “x”. For instance, T_{P} is about 27.9 K for non-doped MCs, which has enhanced steadily from 28.7, 29.3, 29.7, to 30.0 K for x=0.1, 0.2, 0.3, and 0.4 compositions, respectively.

### Example 4: Electrochemical Performance

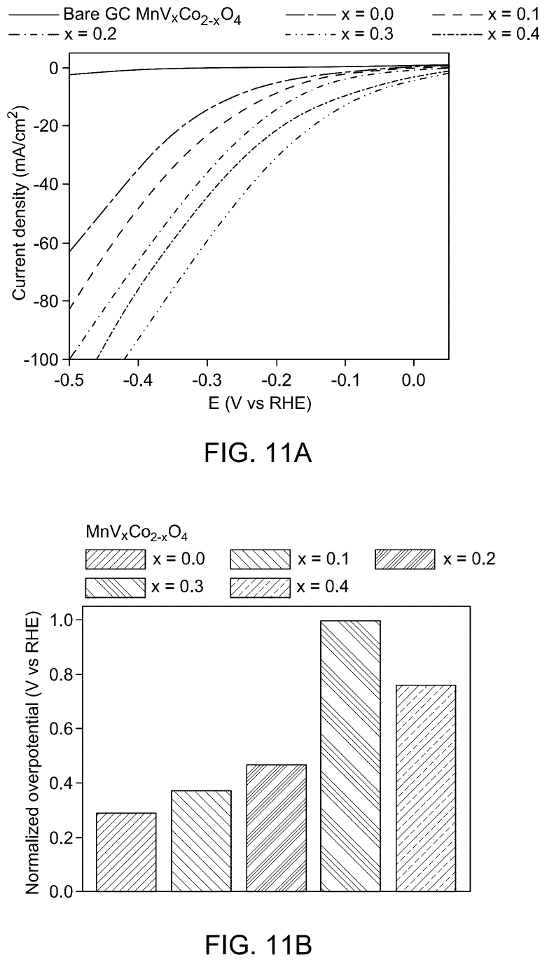

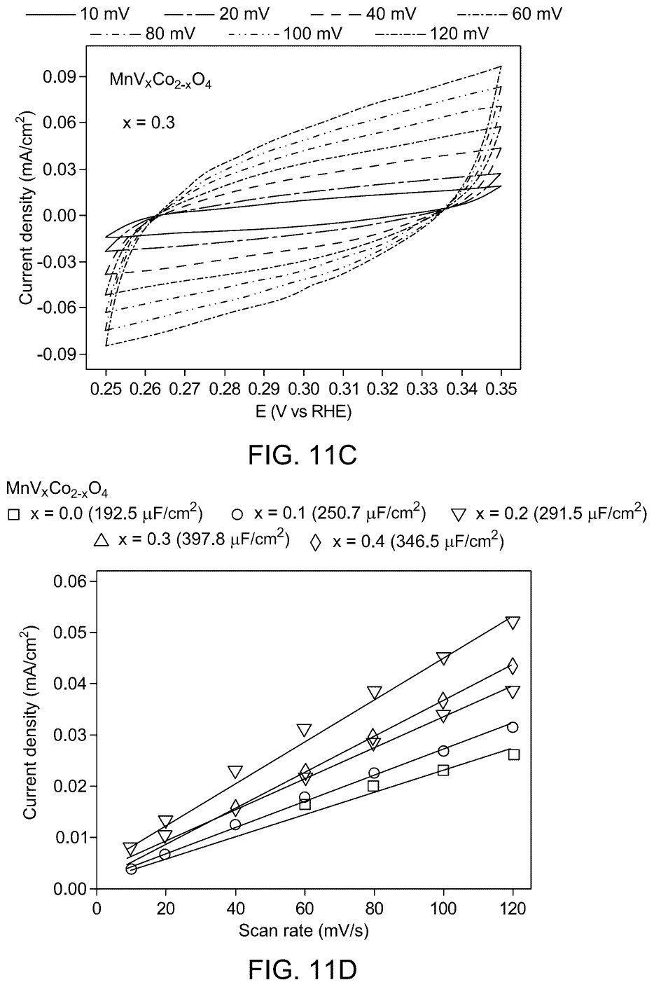

The electrochemical performance of bare and various concentrations of Vₓ—MnCo(x≤0.4) MCs towards HER was assessed in 0.5 M H₂SO₄ electrolyte with a three-electrode configuration. The LSV measurements were carried out to investigate the electrocatalytic activity of representative electrodes. FIG. 11A depicts the LSV acquired by scanning the samples within 0 to −0.5 V versus RHE at a 10 mV/s scan rate. Vₓ—MnCo(x=0.3) MCs electrocatalyst has the lowest onset potential (−78.9 mV), making it the most efficient catalyst among Vₓ—MnCo MCs. The designated Vₓ—MnCo(x=0.3) MCs exhibit remarkable HER activity in the overpotential of merely 85.9 mV to offer 10 mA cm⁻² current density among other different compositions of Vₓ—MnCo MCs. These results revealed that Vₓ—MnCo(x=0.3) MCs performed very well as an HER electrocatalyst, which may be attributed to the deprotonation of water molecules liberating a significant number of H species the Vₓ—MnCo MCs readily absorb. Further, it establishes chemical connections with nearby electrons or adsorbed hydrogen (H_{ads}), and both processes coincide, forming hydrogen gas (H₂) molecules. The remaining samples exhibited relatively low performance, possibly due to the fewer available active sites for the adsorption of hydrogen species and reduced electrochemical surface area. V doping achieves enhanced HER because adding V increases the electrochemical surface area and results in many defective sites, which are advantageous for the rapid transfer of charges. FIG. 11B illustrates a comparison plot of normalized overpotential values at 10 mA/cm² for several samples. The lowest overpotential value of 85.9 mV exhibited by the Vₓ—MnCo(x=0.3) MCs electrocatalyst demonstrates the effectiveness of the composite in catalysing HER, as illustrated in Table 2.

TABLE 2
HER parameters for different catalysts of
Vₓ—MnCo (x ≤ 0.4) MCs electrodes.

| | Onset | Overpotential | Tafel | | |
|---|---|---|---|---|---|
| | potential | (mV) at −10 | slope | DLC | ESCA |
| x | (mV) | mA/cm² | (mV/dec) | (μF/cm²) | (cm²) |
| 0.0 | 141.5 | 268.0 | 131 | 192.5 | 5.5 |
| 0.1 | 129.5 | 211.4 | 115 | 250.7 | 7.2 |
| 0.2 | 114.6 | 169.7 | 103 | 291.5 | 8.3 |
| 0.3 | 78.9 | 85.9 | 84 | 397.8 | 11.4 |
| 0.4 | 104.6 | 109.0 | 96 | 346.5 | 9.9 |

Electron spectroscopy for chemical analysis (ESCA) is an activity parameter relating to electrocatalytic performance, such as double layer capacitance (Cdl) and the specific capacitance (Cs). To confirm the assumption mentioned above for higher activity of Vₓ—MnCo(x=0.3) MCs, the ECSA was measured for bare and Vₓ—MnCo MCs electrodes. The following equation was utilized to calculate the ECSA.

$$ECSA + Cdl / Cs$$

Cdl values were derived using the non-Faradaic potential region in CV curves, and Cs were assumed to be 35 μF cm⁻². FIG. 11C depicts the CV curves obtained for the Vₓ—MnCo(x=0.3) MCs electrocatalyst at scan speeds ranging from 10 to 120 mV/s in the potential range of −0.25 V to −0.35 V versus RHE. FIG. 11D illustrates the linear fit achieved by fitting the current density at a potential of −0.30 V versus RHE against several scan rates. The slope of these straight lines (FIG. 11D) was used to determine the value of Cdl. The ESCA and Cdl values for all the prepared samples of Vₓ—MnCo MCs have been displayed in Table 2. The electrocatalyst Vₓ—MnCo(x=0.3) MCs exhibited outstanding performance with an ECSA value of 11.4 cm². To further examine the catalysts' number of active sites (N), the following equation was utilized to calculate:

$$N = Qs / F$$

where Qs is the surface charge density was derived by integrating the charge of each CV curve over the whole potential range, the half value of the charge was obtained as the Qs values, and F is the Faraday constant (96,485 C mol⁻¹). According to the Qs values, the calculated number of active sites for all the prepared samples of Vₓ—MnCo(x≤0.4) MCs were 1.31×10⁻⁷ mol cm⁻², 1.35×10⁻⁷ mol cm⁻², 1.77×10⁻⁷ mol cm⁻², 2.41×10⁻⁷ mol cm⁻², and 1.82×10⁻⁷ mol cm⁻², respectively. This result confirms that the electrocatalyst Vₓ—MnCo(x=0.3) MCs has more active sites for adsorbing the hydrogen molecules responsible for HER.

The kinetics of the electrocatalytic process was investigated using Tafel analysis, which relates the connection between potential and current density. The corresponding Tafel equation, as in the following equation,

$$η = a + b \times log ( j )$$

where Tafel constant, a; the Tafel slope, b; the current density, j; overpotential, η.

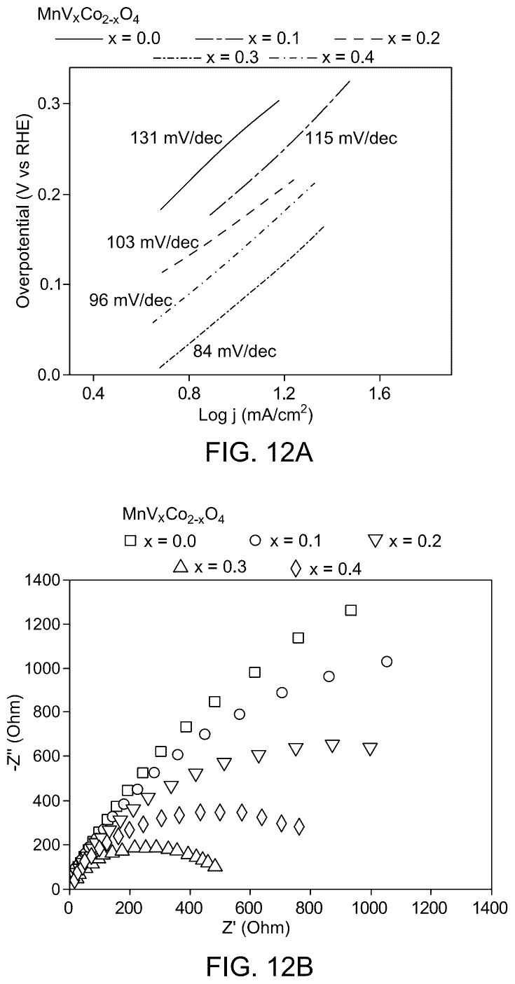

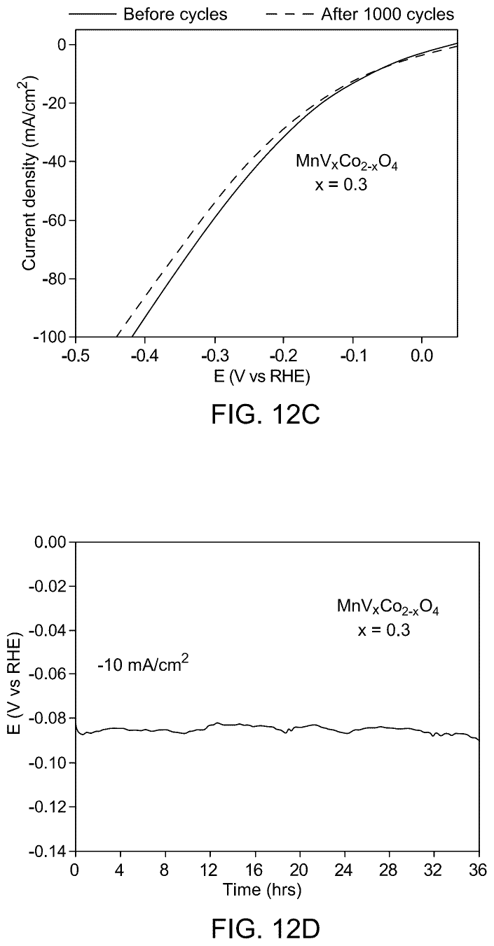

FIG. 12A illustrates Tafel plots for Vₓ—MnCo MCs, with corresponding slopes of 131, 115, 103, 84, and 96 mV/dec, respectively. Vₓ—MnCo MCs (x=0.3) electrocatalyst exhibited Tafel slope values as low as 84 mV/dec, supporting that this material adheres to the Volmer-Heyrovsky rate-determining step in HER. The values of the Tafel slopes represent the reaction route encountered during the catalytic performance. An initial stage, also called the Volmer reaction, involves the hydrogen atom absorbing a discharged proton off the surface of the electrode. In the Heyrovsky process, H_{ads} may combine with a proton and an electron to produce new hydrogen molecules. The Tafel route indicates recombining two H_{ads} species, yielding a hydrogen molecule. The Volmer-Heyrovsky pathway consists of the Volmer and Heyrovsky processes and is the most prevalent mechanism for the HER to proceed. The calculated Tafel slope of 84 mV/dec for the most effective electrocatalyst Vₓ—MnCo MCs (x=0.3) signals that the reaction proceeds via the rate-determining Volmer-Heyrovsky step.

The intense electrocatalytic activity presented by the small semicircle generally shows fast electron transfer at the catalyst electrolyte interface. As illustrated in FIG. 12B, the EIS analysis was conducted to understand the catalyst's efficiency in transferring charges across the interface in 0.5 M H₂SO₄ electrolyte solution. The Nyquist plot of Vₓ—MnCo MCs with an n of 85.9 mV and a frequency range of 0.1 Hz to 105 Hz is depicted in FIG. 12B. Vₓ—MnCo MCs (x=0.3) electrocatalysts exhibited a lower charge transfer resistance than other catalysts. This indicates that it significantly enhanced the HER performance, demonstrating a better ability to transfer electrons at the electrocatalysts/electrolyte interface.

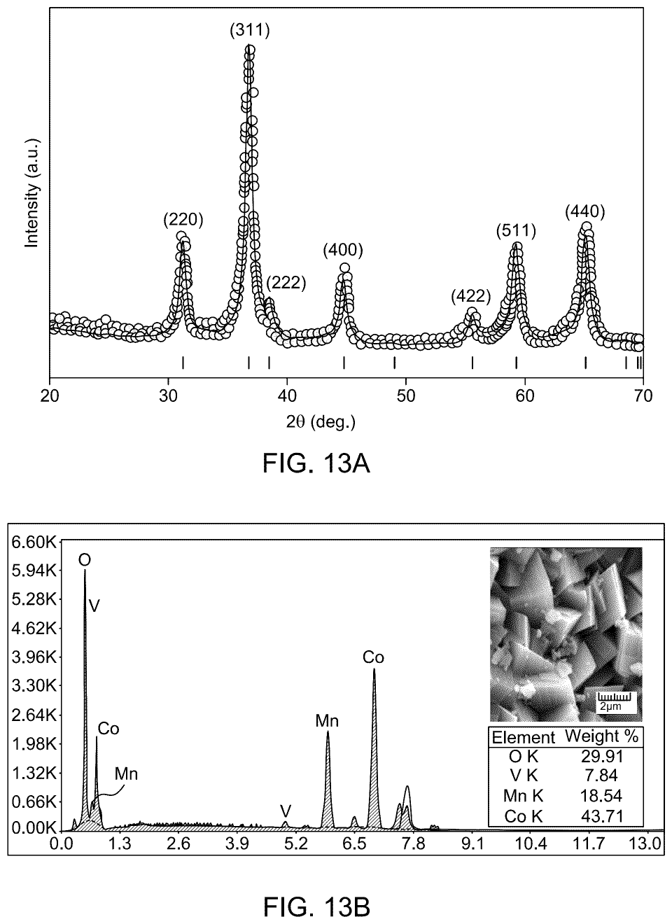

FIG. 12C depicts the LSV used to evaluate the stability of the Vₓ—MnCo(x=0.3) MCs electrocatalyst before and after CV analysis. As seen in FIG. 12C, after 1000 cycles of CV study, the LSV curve of Vₓ—MnCo(x=0.3) MCs electrocatalyst demonstrates almost a change of 4 mV in the overpotential, which is due to the shredding of material from the electrode surface caused by the bubble formation. CP analysis was utilized to further confirm the long-term stability of the electrocatalyst by delivering a constant current of −10 mA/cm² for 36 h in an acidic solution, illustrated in FIG. 12D. The little disruption observed in the CP curve of Vₓ—MnCo(x=0.3) MCs is due to the formation and concentration of bubbles during H₂ release at the electrode surface. However, the electrocatalyst exhibited excellent potential value retention even after 36 h of electrocatalysis at a current density of −10 mA/cm². Following the stability tests, the structure, morphology, and composition of the Vₓ—MnCo(x=0.3) MCs were re-evaluated by XRD (FIG. 13A) and EDX (FIG. 13B) spectrum. However, the morphology exhibited highly agglomerated cubic particles.

Furthermore, no significant changes in the structure and composition were observed. This proves that Vₓ—MnCo(x=0.3) MCs electrocatalysts are highly stable. These findings demonstrate that Vₓ—MnCo(x=0.3) MCs is a high-performance HER electrocatalyst suitable for future hydrogen fuel cell technology. The overpotential comparison of electrocatalytic HER performance of Vₓ—MnCo(x=0.3) MCs with other HER catalysts reported in the literature is listed in Table 3.

TABLE 3
The overpotential comparison of electrocatalytic HER performance of MnVₓCo₂₋ₓ
O₄ with other HER catalysts in an acidic (0.5M H₂SO₄) medium was reported in the literature.

| | Overpotential η (mV) | |
|---|---|---|
| Catalysts | at 10 mA/cm² | References |
| MnVₓCo₂₋ₓO₄ | 85.9 | Present disclosure |
| Mn_{0.9}Co_{0.1}Al₂O₄ | 110 | Homa, S. et al. Synthesis of galaxite, |
| | | Mn_{0.9}Co0.1Al₂O₄, and its application as a |
| | | novel nanocatalyst for electrochemical |
| | | hydrogen evolution reaction. Phys. B |
| | | Condens. Matter. 538, 172-178 (2018). |
| NC/CuCo/CuCoOₓ | 112 | Hou, J. et al. Promoting active sites in |
| | | core-shell nanowire array as Mott- |
| | | Schottky electrocatalysts for efficient and |
| | | stable overall water splitting. Adv. Funct. |
| | | Mater. 28(4), 1704447 (2018). |
| CoSe₂/carbon fiber | 139 | Kong, D. et al. CoSe₂ nanoparticles grown |
| | | on carbon fiber paper: An efficient and |
| | | stable electrocatalyst for hydrogen |
| | | evolution reaction. J. Am. Chem. Soc. |
| | | 136(13), 4897-4900 (2014). |
| NiFe₂O₄ | 150 | Ayan, M. et al. Nanostructured nickel |
| | | ferrite embedded in reduced graphene |
| | | oxide for electrocatalytic hydrogen |
| | | evolution reaction. Mater. Today Energy. |
| | | 8, 118-124 (2018). |
| MnCo₂O₄(50%)/Ti₃C₂Tₓ | 177 | Huajie, H. et al. Coupled spinel |
| | | manganese-cobalt oxide and MXene |
| | | electrocatalysts towards efficient hydrogen |
| | | evolution reaction. Fuel 328, 125234 |
| | | (2022). |
| Exf-NiFe₂O₄/CB | 187 | Tshimangadzo, S. M. et al. A green |
| | | approach for enhancing the electrocatalytic |
| | | activity and stability of NiFe₂O₄/CB |
| | | nanospheres towards hydrogen |
| | | production. Renew. Energy. 154, 704-714 |
| | | (2020). |
| NiCo₂O₄ nanowires | 190 | Liu, D. et al. Hydrogen evolution activity |
| | | enhancement by tuning the oxygen |
| | | vacancies in self-supported mesoporous |
| | | spinel oxide nanowire arrays. Nano Res. |
| | | 11(2), 603-613 (2018). |
| FeSe₂/CoFe₂O₄ | 231 | Huixuan, Z. et al. Successfully synthesis of |
| | | FeSe₂/CoFe₂O₄ heterojunction with high |
| | | performance for hydrogen evolution |
| | | reaction. Renew. Energy. 155, 717-724 |
| | | (2020). |
| CoFe₂O₄-graphene | 248.3 | Ravi, N. et al. Cobalt and nickel ferrites |
| | | based graphene nanocomposites for |
| | | electrochemical hydrogen evolution. J. |
| | | Magn. Magn. Mater. 44, 165-171 (2018). |
| NiFe₂O₄-graphene | 259 | Ravi, N. et al. Cobalt and nickel ferrites |
| | | based graphene nanocomposites for |
| | | electrochemical hydrogen evolution. J. |
| | | Magn. Magn. Mater. 44, 165-171 (2018). |
| MnFe₂O₄-graphene | 313 | Ravi, N. et al. Manganese and zinc ferrite |
| | | based graphene nanocomposites for |
| | | electrochemical hydrogen evolution |
| | | reaction. J. Alloys Compd. 796, 185-195 |
| | | (2019). |
| ZnFe₂O₄-graphene | 315 | Ravi, N. et al. Manganese and zinc ferrite |
| | | based graphene nanocomposites for |
| | | electrochemical hydrogen evolution |
| | | reaction. J. Alloys Compd. 796, 185-195 |
| | | (2019). |
| Porous NiCo₂O₄ | 370 | Elakkiya, R. et al. Flower-like nickel- |
| | | cobalt oxide nanomaterials as bi-functional |
| | | catalyst for electrochemical water splitting. |
| | | Mater. Res. Bull. 116, 98-105 (2019). |
| Ce-MnCo₂O₄ | 389 | Huang, X. et al. Enhanced water splitting |
| | | electrocatalysis over MnCo₂O₄ via |
| | | introduction of suitable Ce content. ACS |
| | | Sustain. Chem. Eng. 7(1), 1169-1177 |
| | | (2019). |
| SrLaAl_{1/2}Mn_{1/2}O₄ | 453 | Sofiul, A. et al. Electrocatalytic activity of |
| | | layered oxides SrLaAl_{1/2}M_{1/2}O₄ (M = Mn, |
| | | Fe, Co) for hydrogen- and oxygen- |
| | | evolution reactions. Mater. Chem. Phys. |
| | | 293, 126942 (2023). |
| Sr₂LaCoMnO₇ | 612 | Kananke-Gamage, C. C. W. et al. |
| | | Variation of the electrocatalytic activity of |
| | | isostructural oxides Sr₂LaFeMnO₇ |
| | | and Sr₂LaCoMnO₇ for hydrogen and |
| | | oxygen-evolution reactions. Dalton Trans. |
| | | 50(40), 14196-14206 (2021). |

Numerous modifications and variations of the present disclosure are possible in light of the above teachings. It is therefore to be understood that within the scope of the appended claims, the invention may be practiced otherwise than as specifically described herein.

1. A method of generating hydrogen, comprising:
applying a potential of −0.1 to −1.0 V to an electrochemical cell,
wherein the electrochemical cell is at least partially submerged in an aqueous solution,
wherein on applying the potential water in the aqueous solution is reduced thereby forming hydrogen,
wherein the electrochemical cell comprises:
an electrocatalyst; and
a counter electrode
wherein the electrocatalyst comprises:
a substrate; and
MnVₓCo₂₋ₓO₄ particles,
wherein x≤0.4,
wherein the MnVₓCo₂₋ₓO₄ particles have a spherical shape,
wherein the MnVₓCo₂₋ₓO₄ particles have an average diameter less than 100 nanometers (nm), and
wherein the MnVₓCo₂₋ₓO₄ particles are dispersed on the substrate to form the electrocatalyst.

2. The method of claim 1, wherein the MnVₓCo₂₋ₓO₄ particles have an average diameter of 5 nm to 30 nm.

3. The method of claim 1, wherein the MnVₓCo₂₋ₓO₄ particles comprise 25 weight percentage (wt. %) to 35 wt. % 0, 1 wt. % to 10 wt. % V, 20 wt. % to 30 wt. % Mn, and 40 wt. % to 50 wt. % Co, based on a total weight of the MnVₓCo₂₋ₓO₄ particles.

4. The method of claim 1, wherein the MnVₓCo₂₋ₓO₄ particles are aggregated forming microspheres.

5. The method of claim 4, wherein the microspheres have an average diameter of 2 micrometers (μm) to 10 μm.

6. The method of claim 1, wherein the MnVₓCo₂₋ₓO₄ particles comprise less than 5 wt. % MnO₂, based on a total weight of the MnVₓCo₂₋ₓO₄ particles.

7. The method of claim 1, wherein the MnVₓCo₂₋ₓO₄ particles have a cubic crystal structure.

8. The method of claim 1, wherein the MnVₓCo₂₋ₓO₄ particles have a crystallite size of 16 nm to 23 nm.

9. The method of claim 1, wherein the MnVₓCo₂₋ₓO₄ particles have a maximum magnetization value greater than 2.0 electromagnetic units per unit mass (emu/g) at 300 Kelvin (K).

10. The method of claim 1, wherein the MnVₓCo₂₋ₓO₄ particles have a maximum magnetization value greater than 12 emu/g at 10 K.

11. The method of claim 1, wherein the electrocatalyst has an overpotential of less than 250 millivolts (mV) at −10 milliampere per square centimeter (mA/cm²).

12. The method of claim 1, wherein the electrocatalyst comprises MnV_{0.3}Co_{1.7}O₄ particles and has an overpotential of 80 mV to 90 mV at −10 mA/cm².

13. The method of claim 1, wherein the electrocatalyst has a Tafel slope of less than 120 mV per decade.

14. The method of claim 1, wherein the electrocatalyst comprises MnV_{0.3}Co_{1.7}O₄ particles and has a Tafel slope of 80 mV per decade (mV/dec) to 90 mV/dec.

15. The method of claim 1, wherein the electrocatalyst comprises MnV_{0.3}Co_{1.7}O₄ particles and has an electrochemical active surface area of greater than 10 cm².

16. The method of claim 1, wherein the substrate is glassy carbon.

17. The method of claim 1, wherein the aqueous solution further comprises an acid.

18. The method of claim 1, wherein the electrocatalyst is made by a method comprising:
mixing urea, a cobalt salt, a manganese salt, and a vanadium salt to form a mixture;
heating the mixture in an autoclave for at least 6 hours at 150° C. 250° C. to form the MnVₓCo₂₋ₓO₄ particles; and
coating the MnVₓCo₂₋ₓO₄ particles on the substrate.

19. The method of claim 7, wherein a portion of the Co atoms in the cubic crystal structure are replaced with V atoms, thereby forming defects.
